(19) United States
(12) Patent Application Publication
(10) Pub. No.: US 2026/0119362 A1
(43) Pub. Date: Apr. 30, 2026

(54) SELF-OPTIMIZING PEER-EVALUATION FRAMEWORK FOR TASK-ORIENTED MULTI-AGENT SYSTEMS

(71) Applicant: BOOMI, LP, Conshohocken, PA (US)

(72) Inventors: Steven LUCAS, Denver, CO (US); Abhay SASWADE, Sunnyvale, CA (US); Ayush PARASHAR, Foster City, CA (US); Thomas BENJAMIN, Foster City, CA (US); Christopher PEDROTTI, San Jose, CA (US)

(73) Assignee: BOOMI, LP, Conshohocken, PA (US)

(21) Appl. No.: 19/343,092

(22) Filed: Sep. 29, 2025

(30) Foreign Application Priority Data
Oct. 25, 2024 (IN) 202411081537
Oct. 25, 2024 (IN) 202411081538

(51) Int. Cl. G06F 11/34

(52) U.S. Cl. CPC G06F 11/3409

(57) ABSTRACT

As artificial intelligence (AI) agents become more prevalent, it has become important to measure their effectiveness. Disclosed embodiments enable autonomous, real-time evaluation of AI agents using a monitoring service and peer AI agents. In an embodiment, calls, by a performing AI agent, to models and tools, during a session, are made through respective gateways which collect session data. A monitoring service acquires the session data from the gateways, and invokes one or a plurality of monitoring AI agents to evaluate the performance of the performing AI agent based on the session data and one or more adaptable session parameters. The result of the evaluation(s) may be stored for analysis and development of the performing AI agent.

### CROSS-REFERENCE TO RELATED APPLICATIONS

The present application claims priority to Indian Patent Application number 202411081537, filed on Oct. 25, 2024, and Indian Patent Application number 202411081538, filed on Oct. 25, 2024, which are both hereby incorporated herein by reference as if set forth in full.

### BACKGROUND

### Field of the Invention

The embodiments described herein are generally directed to artificial intelligence (AI), and, more particularly, to a self-optimizing peer-evaluation framework for systems with multiple task-oriented AI agents.

### Description of the Related Art

A number of platforms exist that enable users to interact with AI agents. An AI agent is a software entity that utilizes artificial intelligence to autonomously perform one or more tasks, in order to achieve an objective set by a human, another software entity (e.g., another AI agent), or other system. An AI agent may comprise or communicate with one or more integrated, local, or remote AI models, such as generative AI models (e.g., generative language models, generative image models, generative coding models, etc.). An AI agent may also communicate with one or more tools that are external to the AI agent, to complete tasks in furtherance of its objective. The AI agent may communicate with an AI model and/or tool using an application programming interface (API).

As AI agents have become more prevalent and consume more and more computational resources, it has become important to measure the effectiveness of the work that AI agents perform. Existing methodologies focus on the general evaluation of artificial intelligence. Some approaches try to focus on the evaluation of foundational large language (LLM) models, while others try to evaluate the performance of AI agents based on user feedback, the effects on business, cost effectiveness, model-based scoring, human-in-the-loop evaluation, or the like. None of the existing methodologies view the AI agent as an entity that can be instructed to do certain work and that may involve interactions with external systems to complete that work.

### SUMMARY

Accordingly, systems, methods, and non-transitory computer-readable media are disclosed for a self-optimizing peer-evaluation framework for systems with multiple task-oriented artificial intelligence (AI) agents.

In an embodiment, a method comprises using at least one hardware processor to: by a monitoring service, receive session data for a session between an end client and a performing artificial intelligence (AI) agent from a model gateway and a tool gateway, wherein the model gateway is a gateway between the performing AI agent and at least one AI model, and wherein the tool gateway is a gateway between the performing AI agent and at least one tool, invoke one or more monitoring AI agents to evaluate a performance of the performing AI agent based on the session data; by the each of the one or more monitoring AI agents, derive one or more performance metrics based on the session data, evaluate the performance of the performing AI agent based on the one or more performance metrics, and return a result of the evaluation to the monitoring service; and by the monitoring service, receive the result of the evaluation from each of the one or more monitoring AI agents, derive performance data based on the received result of the evaluation from each of the one or more monitoring AI agents, and store the performance data.

The method may further comprise using the at least one hardware processor to, by the monitoring service: determine a task complexity score for a task being performed by the performing AI agent; determine one or more success parameters based on the task complexity score; and provide the one or more success parameters to the one or more monitoring AI agents, wherein the evaluation by each of the one or more monitoring AI agents is based on the one or more performance metrics and the one or more success parameters.

The method may further comprise using the at least one hardware processor to, by the monitoring service: determine whether or not the performing AI agent is likely to successfully complete a task being performed by the performing AI agent; and when determining that the performing AI agent is not likely to successfully complete the task, initiate at least one remedial action. The remedial action may comprise terminating the task being performed by the performing AI agent. The remedial action may comprise terminating execution of the performing AI agent. The remedial action may comprise modifying a configuration of the performing AI agent.

The method may further comprise using the at least one hardware processor to, by an agent framework service, create the session by: generating a session identifier for the session; and instantiating the performing AI agent. The method may further comprise using the at least one hardware processor to, by the agent framework service, call the monitoring service to evaluate the performance of the performing AI agent.

The method may further comprise, by the monitoring service, computing one or more raw metrics based on the session data, wherein the one or more performance metrics are derived further based on the one or more raw metrics.

Deriving the one or more performance metrics may comprise applying an AI model to the session data. The AI model may be a large language model.

The result of the evaluation may comprise at least one of the one or more performance metrics. The result of the evaluation may comprise an effectiveness score, wherein the effectiveness score comprises a numerical value representing how effective the performing AI agent was at an instructed task. The result of the evaluation may comprise a trust score, wherein the trust score comprises a numerical value representing how reliably the performing AI agent followed expected behavior.

The method may further comprise using the at least one hardware processor to, by an analytics service: retrieve the stored performance data; and generate an interactive graphical user interface based on the retrieved performance data.

The one or more monitoring AI agents may be a plurality of monitoring AI agents, wherein each of the plurality of monitoring AI agents evaluates the performance of the performing AI agent in parallel with at least one other one of the plurality of monitoring AI agents. The evaluation performed by each of the plurality of monitoring AI agents may differ from the evaluation performed by the at least one other one of the plurality of monitoring AI agents.

The one or more performance metrics may comprise one or more of work completion rate, instruction adherence, tool usage efficiency, latency, or task complexity score.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an data flow for self-optimizing peer evaluation of artificial intelligence (AI) agents, according to an embodiment;

FIGS. 4 and 5 illustrate example processes for self-optimizing peer evaluation of AI agents, according to embodiments; and

FIG. 6 illustrates a development and production flow, in which disclosed embodiments may be utilized, according to an embodiment.

### DETAILED DESCRIPTION

Embodiments of systems, methods, and non-transitory computer-readable media are disclosed for a self-optimizing peer-evaluation framework for systems with multiple task-oriented artificial intelligence (AI) agents. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Infrastructure

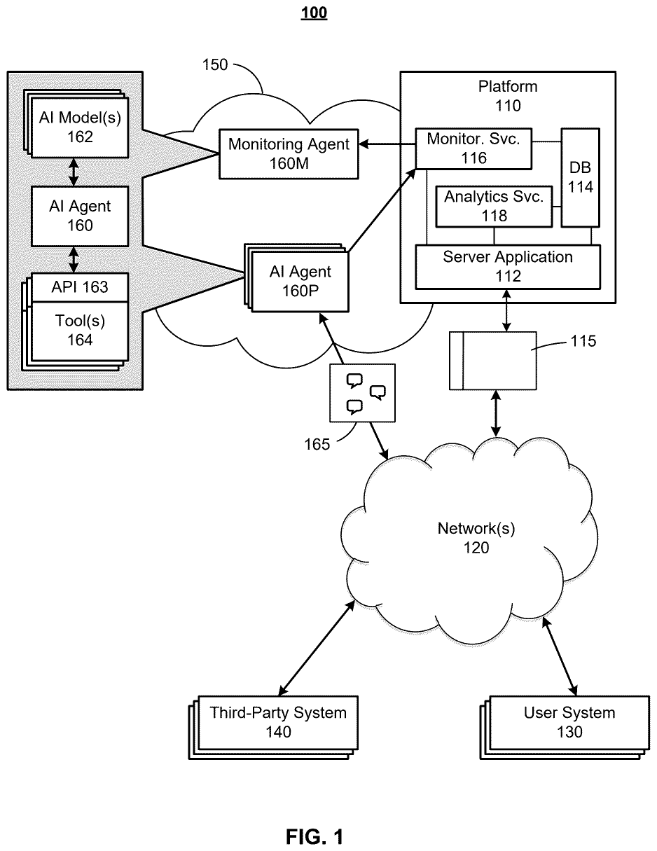

FIG. 1 illustrates an example infrastructure 100, in which one or more of the processes described herein may be implemented, according to an embodiment. Infrastructure 100 may comprise a platform 110 which hosts, supports, and/or executes one or more of the disclosed processes, which may be implemented in software and/or hardware. In particular, platform 110 may execute a server application 112, a monitoring service 116, and/or an analytics service 118. In addition, platform 110 may host or be communicatively coupled to a database 114 that may store data used by server application 112, monitoring service 116, and/or analytics service 118. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and one or more user systems 130 and/or third-party systems 140. Network(s) 120 may comprise the Internet, and communication through network(s) 120 may utilize standard transmission protocols, such as HTTP, HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 and/or third-party system(s) 140 through a single set of network(s) 120, it should be understood that platform 110 may be connected to different user systems 130 and/or third-party systems 140 via different sets of one or more networks. For example, platform 110 may be connected to a subset of user systems 130 and/or third-party systems 140 via the Internet, but may be connected to another subset of user systems 130 and/or third-party systems 140 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal computer or professional workstation of a user, who has a user account for accessing server application 112 on platform 110. It should be understood that the user may be anywhere from an expert software engineer, with extensive knowledge of software, to a business decision-maker, lay person, or other non-technical person, with little to no knowledge of software. Each user account may be associated with an overarching organizational account for managing or utilizing software entities, such as AI agents 160, within a computing environment 150.

Server application 112 may manage computing environment 150. In particular, server application 112 may provide a user interface 115 and backend functionality, including one or more of the processes disclosed herein, to enable or otherwise support users, via user systems 130, to construct, develop, modify, save, delete, test, deploy, un-deploy, utilize, and/or otherwise manage software entities within computing environment 150. User interface 115 may comprise a graphical user interface that implements a low-code environment, including potentially a no-code environment, in which users may construct or utilize software entities. These software entities may comprise AI agents 160, and potentially other software entities, such as integration processes.

The user of a user system 130 may authenticate with platform 110 using standard authentication means, to access server application 112 in accordance with roles or permissions of the associated user account. The user may then interact with server application 112 to manage one or more software entities, for example, within a larger software platform within computing environment 150. It should be understood that multiple users, on multiple user systems 130, may manage the same software entities and/or different software entities in this manner, according to the permissions or roles of their associated user accounts.

Platform 110 may be an integration platform as a service (iPaaS) platform. In this case, the software entities(s) being developed may include integration process(es). Computing environment 150 may comprise one or a plurality of integration platforms that each comprises one or a plurality of integration processes. Each integration platform may be associated with an organization, which may be associated with one or more user accounts by which respective user(s) manage the organization's integration platform, including the various integration process(es). An integration process may represent a transaction involving the integration of data between two or more systems, and may comprise a series of elements that specify logic and transformation requirements for the data to be integrated. Each element, which may also be referred to as a “step,” may transform, route, and/or otherwise manipulate data to attain an end result from input data. For example, a basic integration process may receive data from one or more data sources (e.g., via an application programming interface of the integration process), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software. These integration processes, and/or the development and/or management of these integration processes, may be supported by one or more AI agents 160, and/or the integration processes may support AI agents 160, for example, as tools 164 that are utilized by AI agents 160.

Each AI agent 160 and/or integration process, when deployed, may be communicatively coupled to network(s) 120. For example, each of these software entities may comprise an application programming interface that enables clients to access the software entity, within computing environment 150, via network(s) 120. A client may push data to a software entity through application programming interface, and/or pull data from a software entity through the application programming interface.

One or more third-party systems 140 may be communicatively connected to network(s) 120, such that each third-party system 140 may communicate with an AI agent 160 and/or integration process in computing environment 150 via an application programming interface. Third-party system 140 may host and/or execute a software application that pushes data to an AI agent 160 and/or integration process and/or pulls data from an AI agent 160 and/or integration process, via the application programming interface of the AI agent 160 or integration process. Additionally or alternatively, an AI agent 160 and/or integration process may push data to a software application on third-party system 140 and/or pull data from a software application on third-party system 140, via an application programming interface of the third-party system 140. Thus, third-party system 140 may be a client or consumer of one or more AI agents 160 and/or integration processes, a data source for one or more AI agents 160 and/or integration processes, and/or the like. As examples, the software application on third-party system 140 may comprise, without limitation, enterprise resource planning (ERP) software, customer relationship management (CRM) software, accounting software, and/or the like.

In an embodiment, the software entities(s) being developed and/or otherwise managed on platform 110 include AI agents 160. An AI agent 160 is any software entity that utilizes artificial intelligence (e.g., machine learning, natural-language processing, data analytics, etc.), embodied in one or more AI models 162, to autonomously perform a task, in order to achieve an objective set by a human, other software entity, or other system. AI agent 160 may collect data, analyze data, communicate with human users and/or other software entities, collaborate with other AI agents 160 to complete a complex task, execute actions, learn and improve over time, and/or the like.

Each AI agent 160 comprises or is communicatively coupled to at least one AI model 162. AI model 162 may be internal to AI agent 160, external but local (i.e., within computing environment 150) to AI agent 160, or external and remote (i.e., outside computing environment 150, e.g., hosted on third-party system 140, etc.) from AI agent 160. An AI model 162 may be a generative AI model, such as a generative language model (e.g., small language model, large language model, etc., that responds to natural-language prompts in natural language), generative image model (e.g., that responds to natural-language prompts with an image), generative video model (e.g., that responds to natural-language prompts with a video), generative coding model (e.g., that responds to natural-language prompts with software code), or the like. As used herein, the term “natural language” or “natural-language” refers to language, including grammar, that would be expected in a normal conversation between two humans. A pre-trained generative AI model may be used as a base model that is fine-tuned for the specific task of AI agent 160, to produce AI model 162.

One well-known example of a large language model is the Generative Pre-trained Transformer (GPT). GPT-4 is the fourth-generation language prediction model in the GPT-n series, created by OpenAI of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the DeepSeek family of large language models from DeepSeek AI of Hangzhou, Zhejiang, China, any of the Claude family of large language models (e.g., Claude Opus, Claude Sonnet, etc.) developed by Anthropic PBC of San Francisco, California, the Falcon large language model (e.g., Falcon 160B) released by the United Arab Emirates' Technology Innovation Institute (TII), the Large Language Model Meta AI (LLaMA) model (e.g., LLAMA 2) released by Meta AI of New York, New York, any of the Gemini family of large language models from Google LLC of Mountain View, California, any of the Mistral family of models released by Mistral AI of Paris, France, and the like.

Examples of generative image models include, without limitation, the DALL-E family of models (e.g., DALL-E, DALL-E 2, or DALL-E 3) from OpenAI, Stable Diffusion (e.g., SD 3.5) from Stability AI Ltd of London, England, United Kingdom, Imagen (e.g., Imagen 3) from Google LLC of Mountain View, California, Midjourney form Midjourney, Inc. of San Francisco, California, Adobe Firefly from Adobe Inc. of San Jose, California, Picasso from Nvidia Corp. of Santa Clara, California, Runway Gen-2 from Runway AI, Inc. of New York City, New York, and the like. Examples of generative video models include, without limitation, Runway Gen-2, the Pika family of models from Pika Labs AI of San Francisco, California, Lumiere from Google LLC, VideoLDM from Nvidia, Make-A-Video from Meta Platforms, Inc. of Menlo Park, California, Synthesia from Synthesia of London, England, United Kingdom, DeepBrain AI from AI Studios of Palo Alto, California, Stable Video Diffusion from Stability AI Ltd, and the like.

Examples of generative coding models include, without limitation, Codex from OpenAI, AlphaCode from Google LLC, Code LLAMA from Meta AI, AlphaFold Code from DeepMind Technologies Limited of London, England, United Kingdom, CodeWhisperer from Amazon Web Services of Seattle, Washington, CodeGen from Salesforce, Inc. of San Francisco, California, StarCoder developed by Hugging Face and ServiceNow Research, Tabnine from Tabnine of Tel Aviv, Israel, and the like.

Each AI agent 160 may comprise or be communicatively coupled to zero, one, or a plurality of tools 164. Tool(s) 164 may be hosted within computing environment 150 (e.g., a cloud-computing environment) and/or externally to computing environment 150 (e.g., on a third-party system 140). AI agent 160 may communicate with a tool 164 via an application programming interface 163 of that tool 164. Application programming interface 163 may provide one or more operations that can be performed by AI agent 160 using the respective tool 164. Each operation may accept zero, one, or a plurality of parameters as input and/or return an output that comprises data representing a response, an acknowledgement, and/or the like. An operation, which may also be referred to as an “endpoint,” may be defined by a base Uniform Resource Locator (URL), a path that indicates the resource or action being requested, an HTTP method defining the action to be performed (e.g., GET, POST, PUT, DELETE, etc.), zero, one, or more request parameters, a response format, an authentication or security protocol, a version number, rate limits, error handling, and/or the like.

Tools 164 enable an AI agent 160 to interact with external systems, and even potentially, the physical world. Each tool 164 may perform a task for the overall objective of AI application 160. A task may comprise retrieving data from a source (e.g., another software entity, a local database hosted within computing environment 150, a remote database hosted externally to computing environment 150, a third-party system, application, or database, an integration process, a knowledge base, etc.), transforming, formatting, mapping, cleaning, or otherwise manipulating data, analyzing data, storing data, sending data (e.g., tabular or other structured data, unstructured data, commands, requests, queries, etc.) to a destination (e.g., another software entity, a local database, a remote database, a third-party system, application, or database, an integration process, knowledge base, etc.), initiating a transaction (e.g., purchase, sale, exchange, trade, etc.), completing a transaction, actuating a physical device (e.g., activate a motor, switch, or other machine component, set or adjust a setpoint for a control parameter, etc.), and/or the like.

An AI agent 160 may interact with user systems 130 and/or third-party systems 160, as well as systems within computing environment 150, via an agentic interface 165. Agentic interface 165 may comprise an application programming interface to be used by other software entities and/or a user interface for interaction with user systems 130. AI agent 160 may be a conversational agent, in which case agentic interface 165 may implement a user interface, which may comprise a graphical user interface (e.g., a chat frame into which a user types inputs and AI agent 160 outputs responses), an audio interface (e.g., a speech-to-text engine that converts a user's speech to text for input to AI agent 160 and/or a text-to-speech engine that converts the responses of AI agent 160 to speech), or a combination of graphical and audio user interface (i.e., an audiovisual user interface). The user interface may be comprised within user interface 115. Alternatively, the user interface may be separate and distinct from user interface 115.

At least one of AI agents 160 is a performing AI agent 160P, and at least one of AI agents 160 is a monitoring AI agent 160M. AI agents 160P and 160M may operate in the same manner, but each monitoring AI agent 160M has the task of analyzing performing AI agent(s) 160P. In other words, a monitoring AI agent 160M monitors its peers. In furtherance of this task, monitoring AI agent 160M may interact with monitoring service 116. For example, monitoring agent 160M may be invoked by monitoring service 116 to evaluate data obtained for one or more performing AI agents 160P. It should be understood that a monitoring AI agent 160M may also be a performing AI agent 160P, since a monitoring AI agent 160M may itself be evaluated by other monitoring AI agent(s) 160 via monitoring service 116.

As used herein, a reference numeral with an appended letter will be used to refer to a specific component, whereas the same reference numeral without any appended letter will be used to refer collectively to a plurality of the component or to refer to a generic or arbitrary instance of the component. Thus, for example, the term “AI agents 160” refers collectively to all AI agents 160, including performing AI agent 160P and monitoring AI agent 160M, and the term “AI agent 160” may refer to any single AI agent 160, including potentially performing AI agent 160P or monitoring AI agent 160M.

### 2. Example Processing System

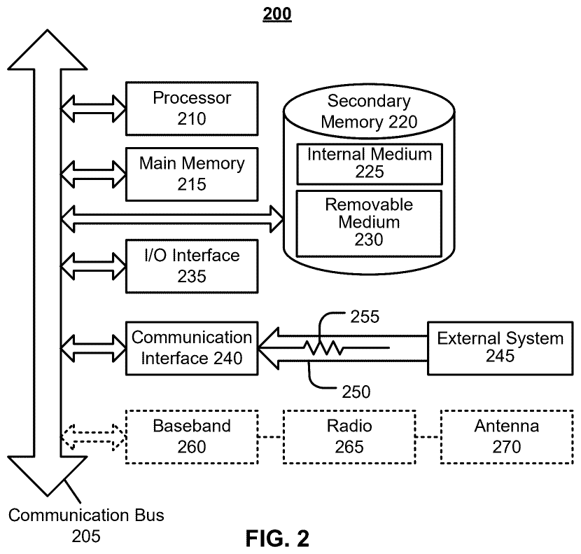

FIG. 2 illustrates an example processing system 200, by which one or more of the processes described herein may be executed, according to an embodiment. For example, system 200 may be used to store and/or execute server application 112, monitoring service 116, analytics service 118, AI agent 160, AI model(s) 162, tool(s) 164, and/or may represent components of platform 110, user system(s) 130, third-party system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Example Data Flow

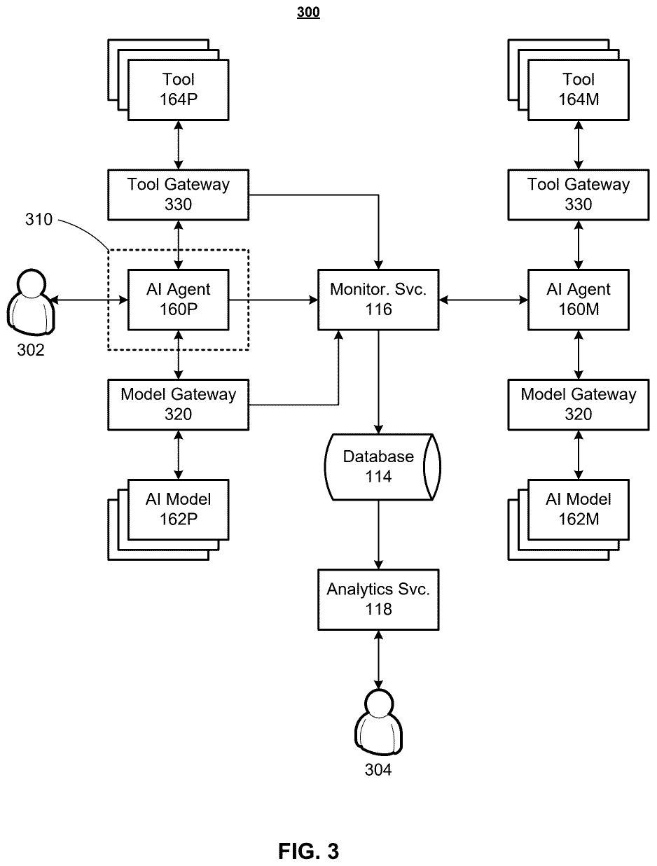

FIG. 3 illustrates an example data flow 300 for self-optimizing peer evaluation of artificial intelligence (AI) agents, according to an embodiment. It should be understood that data flow 300 is shown by way of example, rather than limitation, and that a myriad other arrangements of the data flow are possible. In addition, while only a single performing AI agent 160P and a single monitoring AI agent 160M are illustrated, the data flow may comprise any number of performing AI agents 160P and/or monitoring AI agents 160M, including a plurality of performing AI agents 160P and/or a plurality of monitoring AI agents 160M.

An end client 302 may interact with performing AI agent 160P, via agentic interface 165, to perform a task. End client 302 may be a user, interacting with AI agent 160P, via a graphical user interface of agentic interface 165 rendered at user system 130. Alternatively, end client 302 may be another software entity, interacting with AI agent 160P, via an application programming interface of agentic interface 165, from a third-party system 140. End client 302 may invoke AI agent 160P with an input, such as a query, request, instruction, or the like. In an embodiment in which AI agent 160P is a conversational AI agent, the input may comprise a natural-language expression.

Initially, an agent framework service 310 may create a session between end client 302 and performing AI agent 160P. In particular, agent framework service 310 may generate a session identifier (e.g., unique session identifier) for the session, and then instantiate performing AI agent 160P by invoking the execution function of AI agent 160P, utilizing the input received from end client 302 and/or the session identifier. Agent framework service 310 may also establish connectivity between AI agent 160P and AI model(s) 162P and between AI agent 160P and tool(s) 164P. The session identifier may be added to all logs of AI agent 160P and passed with any calls (e.g., in the header of each call) to AI model(s) 162P and tool(s) 164P, such that data for AI agent 160P can be easily retrieved using the session identifier as an index. At the start of the session, during the session, and/or upon termination of the session, agent framework service 310 may call monitoring service 116 to evaluate the performance of AI agent 160P.

In response to the input, received from end client 302, and in furtherance of its task, performing AI agent 160P may interact with one or more AI models 162P and/or one or more tools 164P. For example, AI agent 160P may prompt an AI model 162P, such as a generative (e.g., small or large) language model, to determine a tool 164P to be utilized in responding to the input, and then AI agent 160P may execute a call to the determined tool 164P. The call may be to retrieve data (e.g., structured and/or unstructured data) required for responding to the input, perform an action as a response to the input, and/or the like. As another example, AI agent 160P may execute a call to a tool 164P to retrieve data required to respond to the input, and then AI agent 160P may prompt an AI model 162P, such as a generative (e.g., small or large) language model, to generate a response from the retrieved data. It should be understood that, in a similar manner, AI agent 160P may utilize one or more AI models 162P and/or one or more tools 164P, in any sequence and arrangement, to generate the response to the input.

In an embodiment, calls to each AI model 162P and each tool 164P are performed by the core of AI agent 160P via a model gateway 320 and a tool gateway 330, respectively. In other words, AI agent 160P may call each AI model 162P via model gateway 320, and call each tool 164P via tool gateway 330. Thus, model gateway 320 acts as a proxy for AI model(s) 162P, and tool gateway 330 acts as a proxy for tool(s) 164P. A call to an AI model 162P may comprise inputting a prompt to AI model 162P (e.g., a natural-language prompt in an embodiment in which AI model 162P comprises a generative language model), inputting a feature vector to AI model 162P (e.g., in an embodiment in which AI model 162P comprises an artificial neural network, or other type of machine-learning model), and/or the like. A call to a tool 164P may comprise executing a remote procedure call, comprising zero, one, or more input parameters, to an endpoint of application programming interface 163 for tool 164P. In each of these cases, the call is made indirectly through the respective gateway, instead of directly to AI model 162P or tool 164P.

Model gateway 320 may process model calls for one or more, including potentially a plurality of, AI agents 160, including performing AI agent 160P and potentially monitoring AI agent 160M. For instance, model gateway 320 may process model calls from all AI agents 160 in computing environment 150, all of a particular organization's AI agents 160, all of a particular user's AI agents 160, and/or the like. In this case, each call to an AI model 162 via model gateway 320 may provide the session identifier (e.g., generated by agent framework service 310) and identify the AI model 162 (e.g., as a network address or other unique identifier of AI model 162), as well as provide the input (e.g., prompt, feature vector, etc.) to AI model 162.

Since model gateway 320 processes all calls to AI model(s) 162, model gateway 320 is able to collect information about all calls to AI model(s) 162. In particular, model gateway 320 may track the time of each model call, data and/or metadata for each model call, any fallback of model call, and/or the like. A fallback may comprise a failure of a call to an AI model 162 due to an error at the model side (i.e., server-side error), the latency of the call (i.e., time duration since the call was made and while no response has been returned) reaching a timeout threshold, or the like. Model gateway 320 may provide all of the collected information to monitoring service 116.

Tool gateway 330 may process calls to tools 164 for one or more, including potentially a plurality of, AI agents 160, including performing AI agent 160P and potentially monitoring AI agent 160M. For instance, tool gateway 330 may process tool calls from all AI agents 160 in computing environment 150, all of a particular organization's AI agents 160, all of a particular user's AI agents 160, and/or the like. In this case, each call to a tool 164 via tool gateway 330 may provide the session identifier (e.g., generated by agent framework service 310) and identify the tool 164 (e.g., as an endpoint), as well as provide any input parameters.

Since tool gateway 330 processes all calls to tool(s) 164, tool gateway 330 is able to collect information about all calls to tool(s) 164. In particular, tool gateway 330 may track the time of each tool call, data and/or metadata for each tool call, any fallback of a tool call, and/or the like. Tool gateway 330 may provide all of the collected information to monitoring service 116.

Each of model gateway 320 and tool gateway 330 acts as a session-aware proxy for AI model(s) 162 and tool(s) 164, respectively. These gateways establish context based on the session identifier that is passed in each call. The information, collected by each gateway, which may comprise one or more statistics (e.g., call latency), counts (e.g., failure counts), and/or the like, may be maintained in the memory of the gateway, in association with the respective session identifier. The time to live for each session's data may be configured for a particular time duration, such as N minutes, where N is determined based on a baseline determined from historical session patterns. When the memory of a gateway is limited, the least recently used session data may get paged from the memory to latent data storage. The gateway may maintain all of the session data for a session during execution of the respective AI agent 160, and then provide all of that session's data to monitoring service 116 for evaluation after the respective AI agent 160 has completed execution and the session has ended. Alternatively, the gateway could provide the session data to monitoring service 116 in real time or periodically during execution of the respective AI agent 160 (i.e., before the session has ended). As used herein, the terms “real time” and “real-time” refer to events that occur simultaneously with each other, as well as events that are temporally separated from each other by ordinary delays caused, for example, by latencies in processing, communications, memory access, and/or the like, including events that are sometimes referred to as near-real-time events. Once a session's data have been provided to monitoring service 116, the gateway may free up the memory used to store that session data.

Once AI agent 160P has completed the task, agent framework service 310 may invoke monitoring service 116, and terminate the session between end client 302 and AI agent 160P. This may cause all of the session's data to be sent from model gateway 320 and tool gateway 330 to monitoring service 116. For example, agent framework service 310 may provide the session identifier to monitoring service 116 at the time of or after invoking monitoring service 116. Monitoring service may then call an application programming interface of model gateway 320 to retrieve all of the session data from model gateway 320 that are associated with the provided session identifier, and call an application programming interface of tool gateway 330 to retrieve all of the session data from tool gateway 330 that are associated with the provided session identifier.

Monitoring service 116 may derive one or more raw metrics from the session data, received from model gateway 320 and/or tool gateway 330. Deriving a raw metric may comprise simply extracting a raw metric from the session data, or may comprise computing, calculating, or otherwise determining the raw metric from information collected by the respective gateway in the session data. The raw metric(s) derived by monitoring service 116 may be persistently stored in database 114.

It should be understood that the raw metrics may comprise anything that quantifies a performance characteristic of AI agent 160P. In an embodiment, the raw metrics include one or more system metrics, one or more work metrics, and/or one or more behavioral metrics. It should be understood that disclosed embodiments are sufficiently flexible to work with additional raw metrics or any different set of raw metrics.

Examples of system metrics include, without limitation, call latency, agent latency, and tool success rate. Call latency refers to the time duration between the time at which a call is made and the time at which a response to the call is received. It should be understood that a call may be a model call (i.e., to an AI model 162P) or a tool call (i.e., to a tool 164P). The call latency may be represented as a set of sub-metrics, such as the average call latency, p50 (i.e., median) call latency, p95 (i.e., 95th percentile) call latency, and/or p99 (i.e., 99th percentile) call latency, across all model calls, all calls to a particular AI model 162, all tool calls, and/or all calls to a particular tool 164. The call latency may be expressed in milliseconds (ms) or any other suitable time format. As an example, the call latency for a particular tool 164P may be: average=385 ms, p50=390 ms, p95=740 ms, p99=760 ms. Th agent latency refers to the time duration between the time at which the input to AI agent 160P was received from end client 302 and the time at which AI agent 160P provides a response to end client 302. The agent latency may be represented in the same manner as call latency (e.g., as an average agent latency, p50 agent latency, p95 agent latency, and/or p99 agent latency). The tool success rate represents how many calls to a tool 164 resulted in a successful response, and may be computed as a ratio of the number of successful calls to a tool 164 to the number of total calls to the tool 164 (e.g., number of successful calls divided by the number of total calls, with the quotient multiplied by one hundred to obtain a percentage).

Once example of a work metric is the work completion rate. Work completion rate represents how many tasks AI agent 160P has successfully completed, and may be computed as a ratio of the number of tasks completed by AI agent 160P to the total number of tasks that AI agent 160P was instructed to perform (e.g., number of completed tasks divided by the number of total instructed tasks, with the quotient multiplied by one hundred to obtain a percentage). As an example, an AI agent 160P that is a flight reservation agent may only book two flights out of four requested flights, in which case the work completion rate would be 50%.

Examples of behavioral metrics include, without limitation, instruction adherence, tool coverage, tool repeat calling rate, and task round trips to model. The instruction adherence may comprise a measured ratio (e.g., percentage) of the actual value of a variable to the expected value of that variable (e.g., work completion, tool utilization, number of tool calls, number of round trips to AI model 162, etc.). The tool coverage refers to a measure of the number of tools 164 used, relative to the number of tools expected to be used. For example, the tool coverage may be computed as a ratio of the number of tools 164 actually used to the number of tools 164 expected to be used (e.g., number of tools 164 used divided by number of tools expected to be used, with the quotient multiplied by one hundred to obtain a percentage). This enables an easy determination of whether or not all of the expected tools 164 were used. Specifically, if the tool coverage is 100%, then AI agent 160P can be validated as having used all expected tools 164. The tool repeat calling rate refers to a measure of the number of times a tool 164 is called, relative to the number of times that tool 164 is expected to be called. For example, the tool repeat calling rate may be computed as the total number of times a tool 164 is called divided by the number of times the tool 164 was expected to be called, with the quotient multiplied by one hundred to obtain a percentage. The task round trips to model refers to the rate of round trips required for an AI model 162 to complete a task. In particular, based on the logic of AI agent 160, AI agent 160 may need to make multiple calls to AI model 162. For example, the task round trips to model may be computed as the total number of calls made to AI model 162 divided by the number of calls expected to be made to the AI model 162, with the quotient multiplied by one hundred to obtain a percentage.

The raw metric(s) may also include user feedback regarding AI agent 160P. For example, in the event that AI agent 160P is a conversational agent that converses with an end user, as end client 302, within a graphical user interface of agentic interface 165, the graphical user interface may comprise a chat frame that has one or more inputs for evaluating the response of AI agent 160P. The input(s) may comprise a positive input (e.g., visually represented as a thumbs-up icon) and/or a negative input (e.g., visually represented as a thumbs-down icon). Alternatively, the input(s) may comprise a textbox, set of radio buttons, drop-down menu, or the like, which enables the end user to specify a number (e.g., an integer value from one to five or one to ten), representing a rating of the response quality (e.g., with higher values representing higher quality, and lower values representing lower quality), and/or natural-language feedback (e.g., with a sentiment identified by a sentiment classifier). When the end user utilizes one of these inputs to provide feedback, an indicator of the specified feedback (e.g., positive or negative, numerical value, sentiment classification, etc.) may be recorded (e.g., in a log of AI agent 160P), and utilized as a raw metric by monitoring service 116, with persistent storage in database 114.

Monitoring service 116 evaluates the efficiency of AI agent 160P on the scale of performance metrics. Monitoring service 116 may receive the configuration of each AI agent 160P to be monitored, in which case the evaluation of AI agent 160P may be based on the configuration of AI agent 160P. Alternatively, or in the event that the configuration of AI agent 160P is not available, the evaluation may be performed in a non-assertive manner, for example, by refraining from drawing any conclusions on the success or failure of AI agent 160P.

In an embodiment, monitoring service 116 utilizes at least one monitoring AI agent 160M to perform the evaluation. In particular, monitoring service 116 may invoke AI agent(s) 160M utilizing, as input, a query or instruction to evaluate AI agent 160P, the session data, representing the runtime information for AI agent 160P, and/or any raw metric(s), derived by monitoring service 116, for AI agent 160P. The session data may comprise the session data received from model gateway 320 for AI agent 160P, the session data received from tool gateway 320 for AI agent 160P, and/or any logs generated for AI agent 160P.

Monitoring service 116 may also provide success parameters as input to monitoring AI agent(s) 160M. The success parameters may define one or more success criteria for evaluating the success or failure of a performing AI agent 160P. A success parameter may be a threshold that defines a success criterion in which a performance metric must satisfy that threshold (e.g., a threshold that a value of the performance metric must be equal to or exceed or a threshold that a value of the performance metric must be less than, to be considered successful).

Monitoring service 116 may dynamically adjust the success parameters, and thereby the one or more success criteria (e.g., increasing or decreasing a threshold), based on one or more factors. These factors may include, without limitation, the complexity of the task performed by AI agent 160P, the criticality of the task performed by AI agent 160P, the prior performance of AI agent 160P, real-time execution trends, and/or the like. For instance, if the task is especially complex, a threshold representing success may be decreased, to thereby broaden the universe of outcomes that represent success. Conversely, if the task is especially critical, a threshold representing success may be increased, to thereby narrow the universe of outcomes that represent success. Dynamic adjustment of the success parameters, in this manner, enhances the flexibility and accuracy of the evaluations performed by monitoring AI agent(s) 160M.

The initial success parameter(s), acceptable ranges of the success parameter(s), and/or the logic or rules for adjusting the success parameter(s) may be defined by a developer of performing AI agent 160P, and stored as part of the configuration of performing AI agent 160P. In other words, the developer may define the success criteria for an AI agent 160. As a concrete example, the success parameters may comprise the tools coverage being greater than or equal to 80%, the repeat tool utilization being within a range of four to eight, the average latency on tools 164 being less than or equal to one second, the token usage being within an expected range, and/or the like.

In an embodiment, monitoring service 116 may predict the effectiveness of AI agent 160P. For example, monitoring service 116 may utilize a predictive model, including potentially a machine-learning model, to estimate the likelihood that AI agent 160P will complete a task successfully. The predictive model may accept, as input, the input received from end client 302, session data from model gateway 320 and tool gateway 330, logs generated for AI agent 160P, and/or the like, and output a probability of success. In the event that the predictive model is a machine-learning model, a training dataset of feature vectors, representing inputs to the machine-learning model and labeled with ground-truth values of success or failure (e.g., a value of one for success, and zero for failure), may be derived from historical session data, and used to train the machine-learning model, via supervised learning, to minimize an error between the actual output of the machine-learning model, after being fed the feature vectors, and the ground-truth values for those feature vectors.

In an embodiment in which monitoring service 116 utilizes a predictive model to predict whether or not AI agent 160P is likely to succeed at a task, monitoring service 116 may be invoked by agent framework service 310 at the start of a task (e.g., when an input is received from end client 302) to predict the likelihood that AI agent 160P will successfully complete the task. When monitoring service 116 determines that AI agent 160P will likely fail at a task, monitoring service 116 may initiate a remedial action. Monitoring service 116 may determine that AI agent 160P will likely fail a task when the predictive model outputs a probability of success that is below a threshold. The threshold may be dynamic (e.g., adjusted according to one or more factors, such as complexity of the task, criticality of the task, etc.) or static. The remedial action may comprise a proactive intervention that prevents the AI agent 160P from wasting unnecessary computational resources by attempting to complete a task at which it is likely to fail. For instance, monitoring service 116 may communicate with AI agent 160P, directly or indirectly via agent framework service 310, to terminate the task. In this case, AI agent 160P may provide a response to end client 302 that informs end client 302 that AI agent 160P is unable to successfully complete the task.

Monitoring service 116 may utilize a single AI agent 160M or a plurality of AI agents 160M for the evaluation of performing AI agent 160P. In an embodiment in which monitoring service 116 utilizes a plurality of AI agents 160M for the evaluation, the plurality of AI agents 160M may execute in parallel or concurrently. Each of the plurality of AI agents 160M may perform the same evaluation or may perform different evaluations. In an embodiment in which the plurality of AI agents 160M perform different evaluations, each of the plurality of AI agents 160M may perform an evaluation in a different one of a plurality of domains. The plurality of domains may represent different sets of performance parameters to be evaluated, different algorithms to be used for the evaluation, different AI models 162M to be used, different tools 164 to be used, and/or the like. In any case, monitoring service 116 may aggregate the results from all of the plurality of AI agents 160M. Advantageously, the cross-validation of evaluations from a plurality of monitoring AI agents 160M increases accuracy and reduces single-source bias.

Each monitoring AI agent 160M is dedicated to evaluating the efficiency of other AI agents 160P, based on the session data, and according to the success parameters, provided by monitoring service 116. In other words, each performing AI agent 160P is evaluated by at least one peer AI agent 160. While the AI agents 160 being evaluated are referred to as performing AI agents 160P, it should be understood that a monitoring AI agent 160M could itself be a performing AI agent 160P that is being monitored by monitoring service 116 and evaluated by one or more other monitoring AI agents 160M. Thus, monitoring AI agents 160M may also communicate with AI model(s) 162M via model gateway 320, and communicate with tool(s) 164M via tool gateway 330.

Monitoring AI agent 160M may comprise pre-built instructions or logic for the general purpose of evaluating the effectiveness of an AI agent 160P. AI agent 160M may utilize AI model(s) 162M (e.g., a large language model), tool(s) 164, statistical techniques (e.g., via one or more tools 164P), and/or the like, to generate one or more performance metrics of the effectiveness of AI agent 160P. AI model 162M may be a small or large language model that is fine-tuned for evaluating the effectiveness of an AI agent 160P, based on collected session data, including potentially one or more raw metrics computed by monitoring service 116. For example, relevant data from the session data may be incorporated into a prompt, with an instruction to generate particular performance metrics for AI agent 160P based on the session data. Then, this prompt may be input into AI model 162M to produce the one or more performance metrics. Alternatively, the one or more performance metrics may be computed using a rule-based logic.

In an embodiment, the derived performance metric(s) are compared to the success parameters (e.g., respective threshold(s) representing success criteria in the success parameters) to determine whether or not AI agent 160P effectively completed its task. Monitoring AI agent 160M may generate one or more assertive evaluation metrics based on these comparisons. Examples of evaluation metrics include, without limitation, a trust score, an indication of whether or not performing AI agent 160P successfully completed the task, whether or not the utilization of tools 164 by performing AI agent 160P satisfied (e.g., exceeded) a threshold percentage, and the like. A result of the evaluation, comprising the performance metric(s) and/or evaluation metric(s), may be returned to monitoring service 116, which may store the result persistently in database 114.

In an embodiment, monitoring AI agent 160M generates a trust score, either as one of the performance metrics (e.g., generated by a machine-learning and/or statistical technique) or an evaluation metric. The trust score may be a numerical value that represents how consistently or reliably AI agent 160P follows expected behavior over time, with higher values representing higher consistency, and lower values representing lower consistency. The trust score provides a reliability metric for better AI governance.

As mentioned elsewhere herein, the success parameters may be dynamic. For example, monitoring service 116 may adjust the success parameters based on one or more factors. As a result, the expectations of monitoring AI agent 160M can be adjusted by adjusting the success parameters (e.g., by increasing a threshold to increase expectations, or decreasing a threshold to decrease expectations). In an embodiment, the factor(s) include the complexity of the task being performed by AI agent 160P. Thus, the expectations of monitoring AI agent 160M can be adjusted according to the complexity of the task being performed by AI agent 160P, such that monitoring AI agent 160M performs complexity-aware evaluation of AI agent 160P.

In an embodiment, monitoring AI agent 160M may generate, in addition to or instead of performance metric(s) and/or evaluation metric(s), one or more suggested optimizations. The suggested optimization(s) may be generated by an AI model 162M (e.g., large language model), based on the session data, performance metric(s), evaluation metric(s), and/or the like. Examples of optimizations include, without limitation, reducing redundant tool calls and/or model calls (e.g., via caching), improving tool selection, alternative API strategies to improve response times, alternative tools 164P (e.g., if one tool 164P frequently fails), and the like. For instance, if AI agent 160P is making inefficient tool calls, the suggestion may comprise alternative execution paths (e.g., new or different endpoints). These suggestions may be utilized to remediate, retrain, reprogram, and/or otherwise improve the operation of AI model 160P, potentially in real time as AI model 160P is performing a task. In this manner, AI agents 160 may be self-optimizing, in the sense that monitoring AI agent(s) 160M evaluate and optimize peer AI agent(s) 160P.

An administrative client 304 may interact with analytics service 118. Administrative client 304 may be a user, interacting with analytics service 118, via a graphical user interface of analytics service 118 (e.g., within user interface 115) rendered at user system 130. Alternatively, administrative client 304 may be another software entity, interacting with analytics service 118, via an application programming interface (e.g., within user interface 115) of analytics service 118, from a third-party system 140. Analytics service 118 may summarize the performance of one or more performing AI agents 160P, based on the performance data stored for AI agent(s) 160P within database 114 by monitoring service 116. It should be understood that the performance data may comprise the performance metrics, evaluation metrics, suggested optimizations, and/or the like, generated by monitoring AI agent(s) 160M.

In an embodiment, analytics service 118 may itself be an AI agent 160. In this case, analytics service 118 may be a conversational AI agent that converses with administrative client 304 using natural language (e.g., within a graphical user interface of user interface 115). In such an embodiment, analytics service 118 may respond to ad hoc queries from administrative users by summarizing the performance data in a graphical user interface (e.g., of user interface 115), such as a dashboard of the administrative user's user account, for consumption by the administrative user. The summary may comprise textual elements (e.g., parameter names and numerical values of the named parameters) and/or graphical elements (e.g., tables, charts, graphs, images, animations, etc.), representing the performance data, as well as one or more inputs for interacting with the textual and/or graphical elements.

Analytics service 118 may utilize a retrieval-augmented generation (RAG) architecture. The RAG architecture combines a retrieval-based component, represented, for example, by tool(s) 164 or a direct query to database 114, with a generation-based component, represented, for example, by AI model 162, which may be a large language model, small language model, or other generative language model. In response to an input from administrative client 304, such as a request to summarize the performance of one or more performing AI agent(s) 160P, analytics service 118 may retrieve performance data from database 114 (e.g., directly or via a tool 164), and then generate a response by applying the AI model 162 to the performance data. The RAG architecture provides dynamic and scalable access to the performance data, improved generalization (e.g., enabling AI model 162 to respond to prompts beyond those for which AI model 162 was trained), and reduced model size (e.g., since AI model 162 does not need to store all relevant data internally). Suitable enhancements to the RAG architecture, which may be used, include Chunked RAG (CRAG), in which the retrieval-based component retrieves relevant chunks of the performance data, and Self-RAG, in which the retrieval-based component is able to retrieve performance data from a store of prior responses, as well as database 114.

In any case in which an AI agent 160, such as AI agent 160P and AI agent 160M, is described as using an AI model 162, such as AI model 162P and AI model 162M, that is a large language model, AI agent 160 may generate an input to AI model 162 based on any of the relevant data available to AI agent 160. In particular, AI agent 160 may incorporate the relevant data into a predefined template to generate a prompt, which may comprise or consist of a natural-language expression. The predefined template may comprise a pre-conversation and/or post-conversation, which provide context and/or instructions for AI model 162, and one or more placeholders into which the relevant data are inserted. The pre-conversation and/or post-conversation may define the role of AI model 162 model (e.g., to respond to a query, request, or other input according to the relevant data and a current context, summarize the relevant data, generate image or video data or software code from the relevant data, perform an action, etc.), define an output format for AI model 162 (e.g., natural language, a table, a list structure, a hierarchical structure, a markup-language structure, etc.), and/or the like. The prompt is input to AI model 162 to produce a response from AI model 162 (e.g., in the output format defined by the prompt). This response is the output of AI model 162, which may then be utilized by AI agent 160, for example, as the response from AI agent 160, to select and/or configure a tool 164, as input to a tool 164, as relevant data for a further input to AI model 162, and/or the like.

### 4. Process for Monitoring Service

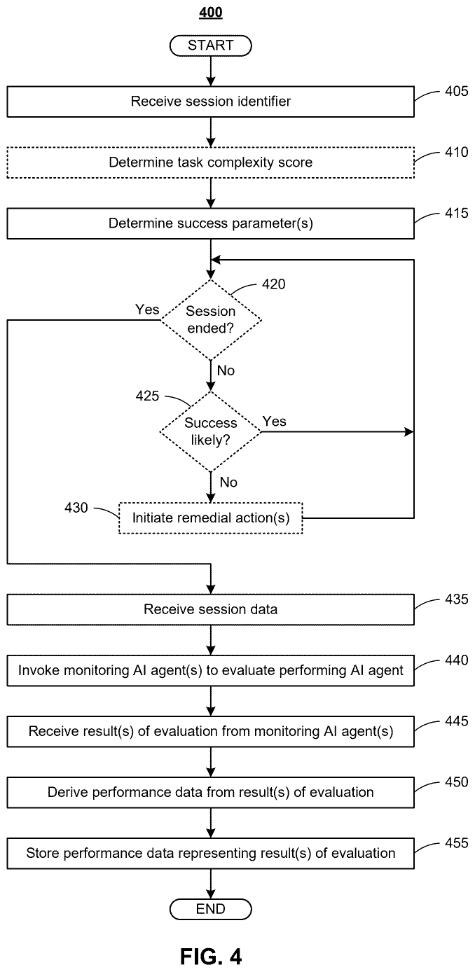

FIG. 4 illustrates an example process 400 for self-optimizing peer evaluation of artificial intelligence (AI) agents 160, according to an embodiment. Process 400 may be implemented by monitoring service 116. Process 400 may be performed for each performing AI agent 160P to be monitored.

While process 400 is illustrated with a certain arrangement and ordering of subprocesses, process 400 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Initially, subprocess 405 may receive a session identifier, which identifies, and preferably uniquely identifies, a session between an end client 302 and a performing AI agent 160P. For example, monitoring service 116 may be invoked by agent framework service 310 using the session identifier. All of the session data, comprising the runtime information of performing AI agent 160P, for a session may be indexed by that session's session identifier. Thus, once invoked, monitoring service 116 may retrieve session data from one or more sources, including model gateway 320, tool gateway 330, logs generated by and/or for the performing AI agent 160P, and/or the like.

It should be understood that, at the time that monitoring service 116 is invoked, performing AI agent 160P may be about to start performing a task, in the midst of performing the task, or have completed the task, depending on the particular implementation. The task may be performed in response to an input from end client 302 to performing AI agent 160P. As one non-limiting example, performing AI agent 160P may be an AI-powered travel assistant that is provided, as input, a request from end client 302 to “book a flight from New York to London for $500 or less.” In this case, the task for performing AI agent 160P is to book a flight from New York to London for $500 or less, and an evaluation of the task may comprise determining whether or not performing AI agent 160P successfully booked the flight, and if not, determining whether or not the failure was due to there being no available flight or because performing AI agent 160P was not able to properly interaction with tool(s) 164P to retrieve available flights, book an available flight, complete a purchase of an available flight, or the like.

In furtherance of its task, performing AI agent 160P may interact with one or more AI models 162P and/or one or more tools 164P. Continuing the example of a travel assistant, performing AI agent 160P may retrieve flight information from one or more airline reservation tools 164P, utilize AI model 162P to select a flight, if any, that satisfies the requirements of end client 302 (e.g., a flight from New York to London that is less than or equal to $500 in cost), book the selected flight via an airline reservation tool 164P, and interact with a payment tool 164P to complete the transaction. If performing AI agent 160P is unable to complete the task (e.g., because there is no flight from New York to London that is less than or equal to $500 in cost), performing AI agent 160P may utilize AI model 162P to generate a response that informs end client 302 that the task could not be completed and why the task could not be completed. As described elsewhere herein, all calls to AI model(s) 162P and tool(s) 164P may be proxied through model gateway 320 and tool gateway 330, respectively, which collect session data about each such call.

Subprocess 410 may determine a task complexity score for the task being performed by performing AI agent 160P. The task complexity score may be a numerical value that represents the complexity of the task, with higher values indicating higher complexity, and lower values indicating lower complexity. The task complexity score may be computed based on one or more factors, such as the number of calls (e.g., model calls and/or tool calls) required or expected to be required to complete the task, the complexity of calls required or expected to be required to complete the task, computational time required or expected to be required to complete the task, the number of constraints imposed on the task, the complexity of constraints imposed on the task, the number of tokens required or expected to be required to complete the task, and/or the like. In an embodiment in which two or more factors are used to compute the task complexity score, the values of different factors may be combined into the task complexity score using respective weights or in any other suitable manner. It is contemplated that the task complexity score would be computed or otherwise generated by monitoring service 116. However, the task complexity score could alternatively be generated by another software entity, such as agent framework service 310 or performing AI agent 160P itself, and passed as an input to monitoring service 116 (e.g., by agent framework service 310). In an alternative embodiment, a task complexity score may not be utilized, in which case subprocess 410 may be omitted.

Subprocess 415 may determine one or more success parameters to be used for evaluating the performance of performing AI agent 160P. In an embodiment in which the success parameter(s) are static, subprocess 415 may comprise retrieving the success parameter(s) from memory or database 114. However, in a preferred embodiment the success parameter(s) are determined dynamically based one or more factors. In particular, in an embodiment that determines a task complexity score in subprocess 410, the success parameter(s) may be defined based on the task complexity score, with higher task complexity scores resulting in different success parameter(s) than lower task complexity scores. As discussed elsewhere herein, the success parameter(s) may comprise thresholds for one or more evaluation metrics. In this case, the value of one or more thresholds may be increased or decreased based on the task complexity score.

Subprocess 420 may determine whether or not the session between end client 302 and performing AI agent 160P has ended. When the session has ended, agent framework service 310 may communicate that the session has ended to monitoring service 116. In this case, subprocess 420 comprises receiving the communication that the session has ended from agent framework service 310. When determining that the session has not yet ended (i.e., “No” in subprocess 420), process 400 may proceed to subprocess 425. Otherwise, when determining that the session has ended (i.e., “Yes” in subprocess 420), process 400 may proceed to subprocess 445.

Subprocess 425 may determine whether or not performing AI agent 160P is likely to complete its task successfully. As discussed elsewhere herein, monitoring service 116 may utilize a predictive model to predict the probability that performing AI agent 160P will complete the task successfully. When this probability fails to satisfy a threshold (e.g., is less than a threshold), subprocess 425 may determine that performing AI agent 160P is not likely to complete the task successfully, and therefore, is likely to fail the task. When determining that performing AI agent 160P is likely to complete the task successfully (i.e., “Yes” in subprocess 425), process 400 may return to subprocess 420. Otherwise, when determining that performing AI agent 160P is not likely to complete the task successfully (i.e., “No” in subprocess 425), which is another way of saying that performing AI agent 160P is likely to fail the task, process 400 may proceed to subprocess 430.

Subprocess 430 may initiate at least one remedial action. The remedial action(s) may comprise any action designed to prevent or mitigate the failure of performing AI agent 160P. For example, the remedial action(s) may include, without limitation, terminating the task being performed by performing AI agent 160P, terminating the execution of performing AI agent 160P, suggesting one or more corrective actions, automatically implementing one or more corrective actions, and the like. A corrective action may comprise, for example, modifying a configuration of performing AI agent 160P, such as modifying one or more success parameters, one or more hyperparameters of AI model 162P, an AI model 162P called by performing AI agent 160P, a tool 164P called by performing AI agent 160P (e.g., changing an endpoint used by performing AI agent 160P), and/or the like. After initiating the remedial action(s), process 400 may return to subprocess 420.

As mentioned above, the remedial action(s) may comprise terminating the task being performed by performing AI agent 160P. For example, monitoring service 116 may communicate with agent framework service 310 and/or performing AI agent 160P (e.g., via an application programming interface of the respective software entity) to provide an instruction requesting termination of the task. In response, performing AI agent 160P may terminate the task that it was performing, and/or agent framework service 310 may terminate the execution of performing AI agent 160P.

As mentioned above, the remedial action(s) may comprise suggesting and/or implementing one or more corrective actions. For example, subprocess 430 may utilize any suitable logic, predictive model, and/or the like, to determine whether or not there is are any corrective action(s) that would prevent the failure of performing AI agent 160P. A corrective action may include, without limitation, changing a configurable parameter of performing AI agent 160P, adjusting an amount of computational resources (e.g., processing units, memory units, network bandwidth, etc.) that are allocated to performing AI agent 160P, modifying the input to performing AI agent 160P (e.g., enhancing the input), AI model 162P (e.g., adjusting the prompt), and/or tool 164P (e.g., adjusting one or more input parameters, changing an endpoint), and/or the like. Examples of configurable parameters that may be changed in a corrective action include, without limitation, an AI model 162P and/or tool 164P used by performing AI agent 160P, a timeout value, a hyperparameter, a constraint, a security setting, and the like. When determining that such corrective action(s) exist, monitoring service 116 may provide the corrective action(s) to agent framework service 310. Agent framework service 310 may automatically implement the corrective action(s), if possible, and/or control or otherwise cause performing AI agent 160P to suggest the corrective action(s) to end client 302 through agentic interface 165 (e.g., graphical user interface) of performing AI agent 160P for manual implementation.

Subprocesses 425-430 represent an optional feature of process 400 that predictively determines whether or not performing AI agent 160P is likely to fail, and if so, is able to initiate a remedial action to prevent or reduce the waste of computational resources allocated to the task. In an alternative embodiment, this feature may be omitted, in which case subprocesses 425-430 may be omitted. In this case, the “No” branch at the output of subprocess 420 may return to the input of subprocess 420, to await the end of the session.

Subprocess 435 may receive session data for the session between end client 302 and performing AI agent 160P. The session data, representing runtime information for performing AI agent 160P, may be retrieved or otherwise received from model gateway 320 and/or tool gateway 330. In this case, the session data may comprise one or more statistics collected by model gateway 320 and/or tool gateway 330. As discussed elsewhere herein, model gateway 320 is a gateway between performing AI agent 160P and at least one AI model 162P, and tool gateway 330 is a gateway between performing AI agent 160P and at least one tool 164P. Model gateway 320 acts as a proxy for AI model(s) 162P, and tool gateway 330 acts as a proxy for tool(s) 164P. The session data may also comprise logs and/or other runtime information generated by and/or for performing AI agent 160P.

In an embodiment, monitoring service 116 may compute or otherwise derive one or more raw metrics based on the session data, received in subprocess 435. For example, the raw metric(s) may be computed, extracted, or otherwise derived from statistic(s) in the session data. The raw metric(s) may be added to the session data and/or otherwise associated with the session data when invoking monitoring AI agent(s) 160M.

Subprocess 440 may invoke one or more monitoring AI agents 160M to evaluate a performance of performing AI agent 160P based on the session data, received in subprocess 435. Each monitoring AI agent 160M may be invoked in a similar or identical manner as described above with respect to performing AI agent 160P. For example, agent framework service 310 may generate a new session identifier for the session between monitoring service 116 and monitoring AI agent 160M, and then instantiate monitoring AI agent 160M using the newly generated session identifier, the success parameter(s) determined in subprocess 415, and the session data (e.g., including raw metric(s), if any, generated by monitoring service 116) received in subprocess 435. In fact, a monitoring AI agent 160M may itself be a performing AI agent 160P whose performance is monitored by monitoring service 116, and potentially other monitoring AI agents 160M. In an alternative embodiment, monitoring AI agents 160M may be invoked in a different manner.

In an embodiment, subprocess 440 invokes a plurality of monitoring AI agents 160M. Each of the plurality of monitoring AI agents 160M may evaluate the performance of performing AI agent 160P in a different one of a plurality of domains (e.g., according to different sets of performance parameters and/or algorithms, using different AI models 162M and/or tools 164M, etc.). In other words, the evaluation performed by each of the plurality of monitoring AI agents 160M may differ from the evaluation performed by at least one other one of the plurality of monitoring AI agents 160M. The plurality of monitoring AI agents 160M may be executed in parallel or concurrently, to reduce latency in the overall evaluation. In other words, the plurality of monitoring AI agents 160M may evaluate the performance of performing AI agent 160P in parallel.

Subprocess 445 may receive the result of evaluation from each of the one or more monitoring AI agents 160M that were invoked in subprocess 440. The result of an evaluation may comprise an effectiveness score for performing AI agent 160P, one or more performance metrics utilized by monitoring AI agent 160M, one or more success parameters that were relevant to the effectiveness score, a trust score comprising a numerical value representing how reliably performing AI agent 160P followed expected behavior, a natural-language expression of the effectiveness of performing AI agent 160P, one or more suggestions for how to improve or optimize the effectiveness of performing AI agent 160P, and/or the like. Once a monitoring AI agent 160M returns the result of its evaluation, that monitoring AI agent 160M may be terminated (e.g., by agent framework service 310, in the same manner as performing AI agents 160P).

Subprocess 450 may derive performance data based on the result(s) of evaluation, received in subprocess 445 from each of the monitoring AI agent(s) 160M. In an embodiment in which only a single monitoring AI agent 160M is invoked in subprocess 440, the performance data may comprise or consist of the result of evaluation received in subprocess 445. In an embodiment in which a plurality of monitoring AI agents 160M are invoked in subprocess 440, monitoring service 116 may aggregate the results of evaluations from all of the plurality of monitoring AI agents 160M into the performance data. Any suitable aggregation technique may be used. For example, monitoring service 116 may generate a single effectiveness score as a weighted combination of all of the effectiveness scores received from the plurality of monitoring AI agents 160M, as the maximum effectiveness core, the minimum effectiveness score, the mean effectiveness score, the median effectiveness score, or the like. Monitoring service 116 may do the same if differing values of the same performance metric are returned by different monitoring AI agents 160M for any performance metric. Monitoring service 116 may also deduplicate the results of evaluations to avoid redundant data in the performance data. Alternatively or additionally, the performance data may be derived from the result(s) of evaluation in some other manner, potentially with pre-processing and/or post-processing of the result(s) and/or aggregated result.

Subprocess 455 may store performance data, derived in subprocess 450 and representing the result(s) received in subprocess 445. For example, the performance data may be stored in persistent storage, such as database 114. As discussed elsewhere herein, the performance data may be accessed by analytics service 118, for example, for visualization of the effectiveness of AI agent 160P within a graphical user interface and/or other downstream analysis. In particular, analytics service 118 may retrieved the performance data, stored in subprocess 455, and generate an interactive graphical user interface based on the retrieved performance data.

In the illustrated embodiment, it is assumed that monitoring service 116 does not initiate a performance evaluation of performing AI agent 160P until after the session has ended. In an alternative embodiment, monitoring service 116 may initiate the performance evaluation of performing AI agent 160P during the session, such that the performance of performing AI agent 160P is evaluated in real time. In such an embodiment, process 400 may be reconfigured, such that subprocesses 435-455 are performed iteratively, in real time, as performing AI agent 160P is executed. Each iteration may be triggered by the completion of a task or sub-task within the session, such that the performance of performing AI agent 160P is evaluated for each task or sub-task. Alternatively, the iterations may be triggered in some other suitable manner, such as by the expiration of a time interval, the occurrence of another particular event, and/or the like.

In the illustrated embodiment, it is assumed that monitoring service 116 is invoked prior to the completion of execution of performing AI agent 160P. In an alternative embodiment, monitoring service 116 may be invoked after performing AI agent 160P has completed execution and the session has ended. In this case, subprocesses 420-430 may be omitted, and subprocess 415 may proceed directly to subprocess 435.

### 5. Process for Monitoring AI Agent

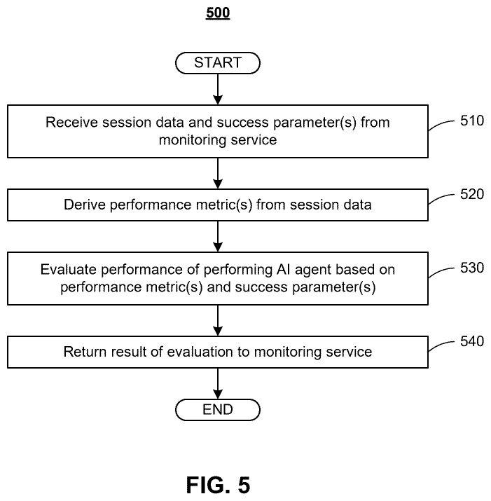

FIG. 5 illustrates an example process 500 for self-optimizing peer evaluation of artificial intelligence (AI) agents 160, according to an embodiment. Process 500 may be implemented by monitoring AI agent 160M. Process 500 may be performed each time that monitoring AI agent 160M is invoked by monitoring service 116.

While process 500 is illustrated with a certain arrangement and ordering of subprocesses, process 500 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Initially, subprocess 510 may receive session data and one or more success parameters. It should be understood that the session data and success parameter(s) may be provided by monitoring service 116 at or after the time that monitoring AI agent 160M is invoked. The session data may comprise one or more raw metrics derived by monitoring service 116.

Subprocess 520 may derive one or more performance metrics based on the session data, received in subprocess 510. The performance metrics may be derived based on the raw metrics and/or other runtime information in the session data. In a simple case, a performance metric may be a raw metric from the session data. Alternatively, a performance metric may be computed from a raw metric or set of raw metrics or from other runtime information in the session data.

Examples of performance metrics include, without limitation, work completion rate, instruction adherence, tool usage efficiency, latency, and task complexity score. The work completion rate represents the rate at which performing AI agent 160P completed its tasks, and may be expressed as a ratio or percentage of the number of successfully completed tasks (e.g., in which a response was returned to end client 302) to the total number of tasks. The instruction adherence represents the rate at which performing AI agent 160P followed instructions, and may be expressed a ratio or percentage of the number of followed instructions to the total number of instructions. The tool usage efficiency represents whether or not performing AI agent 160P used the correct tools 164P at the right time, and may be expressed, for example, as a ratio or percentage of the number of tools 164P actually used to the number of tools 164P expected to be used. The latency represents the time duration required for performing AI agent 160P to complete a task, and may be expressed as the time duration between the time at which the task was started and the time at which the task was completed. The task complexity score, which is described elsewhere herein, represents the complexity of the task performed by performing AI agent 160P, and may be expressed as a numerical value.

As discussed elsewhere herein, deriving the one or more performance metrics may comprise applying an AI model 162M to the session data. This AI model 162M may be a generative language model, such as a large language model. In this case, relevant data from the session data may be incorporated into a prompt with an instruction to generate the performance metric(s). This prompt may be input to AI model 162M which may generate the instructed performance metric(s).

Subprocess 530 may evaluate the performance of performing AI agent 160P based on the performance metric(s), derived in subprocess 520, and/or the success parameter(s), received in subprocess 510. This evaluation may comprise comparing each of at least a subset of the performance metric(s) to one or more respective thresholds in the success parameter(s), which represent expected or normal behavior of performing AI agent 160P, based, for example, on historical performance of performing AI agent 160P and/or similar AI agents 160. For instance, the work completion rate may be compared to a threshold, representing an expected work completion rate, to determine whether or not performing AI agent 160P is completing work at the expected rate. Similarly, the instruction adherence may be compared to a threshold, representing an expected instruction adherence, to determine how well AI agent 160P followed instructions. As another example, tool usage efficiency may be compared to a threshold, representing acceptable tool usage, to determine whether or not performing AI agent 160P used the correct tools 164P at the correct times. As yet another example, latency may be compared to a threshold, representing acceptable latency, to determine whether or not a task was completed by performing AI agent 160P in a reasonable amount of time.

Subprocess 530 may comprise applying at least one AI model 162M to one or more of the performance metric(s) and/or the success parameter(s). AI model 162M may be a machine-learning model, statistical model, or other type of model. In an embodiment, AI model 162M receives the performance metric(s) and success parameter(s) as input, and outputs an effectiveness score. The effectiveness score may comprise a numerical value representing how effective performing AI agent 160P was at its instructed task, for example, on a scale of zero (e.g., representing least effective) to one or one hundred (e.g., representing most effective). The effectiveness score may be compared to a predicted effectiveness score (e.g., as a ratio or percentage of the actual effectiveness score to the predicted effectiveness score) to assess how well performing AI agent 160P performed relative to expectations. Alternatively or additionally, AI model 162M may output a natural-language assessment of the performance of performing AI agent 160P, a graphical assessment (e.g., table, chart, graph, etc.) of the performance of performing AI agent 160P, one or more suggestions for optimizing the execution of performing AI agent 160P, and/or the like. In an embodiment, multiple AI models 162M may be used to generate combinations of two or more such outputs.

Subprocess 540 may return the result of the evaluation to monitoring service 116. This result may comprise any of the output(s) of AI model(s) 162M, described above, including one or more performance metrics, the effectiveness score, the trust score, a natural-language, graphical, or other assessment of the performance of performing AI agent 160P, one or more suggestions for optimizing the execution of performing AI agent 160P, and/or the like.

### 6. Example Embodiments

Disclosed embodiments enable autonomous, real-time evaluation of AI agents 160 using predictive scoring, modeling of task complexity, and/or a multi-agent peer evaluation framework, to generate performance metrics, including trust metrics. The evaluation framework measures the effectiveness of a performing AI agent 160P from the perspective of the work that the performing AI agent 160P is instructed to do, with the performance metrics designed to measure the effectiveness of work done. It perceives a performing AI agent 160P as similar to a human who accepts instructions and completes tasks by interacting with other humans and external systems. This approach goes beyond measuring only model performance, and focuses on a holistic measure of other aspects of agentic performance, such as how performing AI agent 160P autonomously interacts with the world outside of AI models 162P, how performing AI agent 160P utilizes the instructions it receives, and/or the like. While this approach is generally applicable to all AI agents 160, it is particularly well-suited for AI agents 160 that cater to enterprise or industrial workforce domains.

At a high level, monitoring AI agent(s) 160M, in conjunction with monitoring service 116, may leverage a superior AI model 162M (e.g., large language model) to evaluate the effectiveness of performing AI agent(s) 160P, and store the results of the evaluation to a database 114 as performance data. Analytics service 118 may then utilize the performance data, such as by publishing the performance data to a dashboard so that users can visualize the effectiveness of performing AI agents 160P, and leverage insights learned from this visualization to similar AI agents 160.

In typical operation, an AI agent 160P performs a task, based, for example, on instructions within a user input from end client 302. While AI agent 160P performs the task, monitoring service 116 will monitor the execution of performing AI agent 160P. This may comprise logging key metrics, such as the number of API calls made by performing AI agent 160P, the time required by performing AI agent 160P to perform each sub-task, how many instructions did performing AI agent 160P follow, how many retries were required before successful completion of the task, and/or the like. In addition, monitoring service 116 may dynamically adjust the success parameters used to define the performance of performing AI agent 160P. For example, thresholds within the success parameters may be adaptive, based on task complexity, historical performance, and/or the like, instead of being static or fixed.

Next, one or more monitoring AI agents 160M are invoked to evaluate the effectiveness of performing AI agent 160P, by comparing the actual behavior of performing AI agent 160P to expected behavior, and generate an effectiveness score for performing AI agent 160P. Monitoring AI agent 160M may detect deviations from expected behavior, such as performing AI agent 160P taking too long to perform a sub-task, using the wrong tool 164P for a sub-task, making unnecessary retries to the same tool 164P instead of switching to an alternative tool 164P, and/or the like. In an embodiment, a plurality of monitoring AI agents 160M evaluate the effectiveness of performing AI agent 160P, in parallel, to form a multi-agent peer review system that results in improved accuracy and unbiased effectiveness scoring.

Once monitoring AI agent(s) 160M have completed evaluation, monitoring service 116 stores the result as performance data within database 114. The performance data, which may comprise an effectiveness score for performing AI agent 160P, may be used for human review (e.g., an administrative user may review the performance of performing AI agent 160P), automated feedback loops (e.g., to retrain performing AI agent 160P, or more particularly, AI model 162P, based on performance patterns represented in the performance data), dashboard visualizations (e.g., to display real-time metrics for administrative client 304), and/or the like.

In an embodiment, a trust score may be assigned to each performing AI agent 160P. The trust score represents a measure of the reliability of the respective AI agent 160P, and may be generated based on past performance data. AI agents 160P with low trust scores may be flagged for deeper analysis.

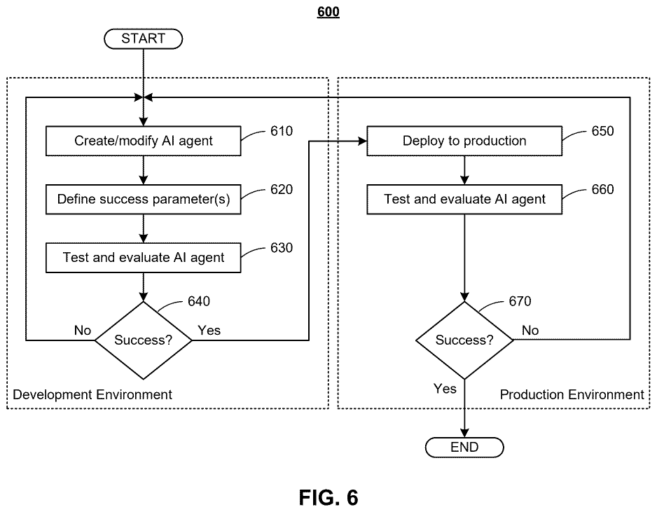

FIG. 6 illustrates a development and production flow 600, in which disclosed embodiments may be utilized, according to an embodiment. In particular, disclosed embodiments may be utilized in flow 600 to evaluate an AI agent 160 within a development environment and/or a production environment.

Initially, in subprocess 610, a user may create a new AI agent 160P or modify an existing AI agent 160P. At first, this new or modified AI agent 160P may be tested within the development environment, to prevent the new or modified AI agent 160P from causing potential harm in the production environment, prior to it being fully evaluated. It should be understood that in the development environment, AI agent 160P executes within a sandbox in which it is unable to modify production data and systems or do other potential harm to the production environment.

In addition, in subprocess 620, the user may define the success parameter(s) for the new or modified AI agent 160P. As discussed elsewhere herein, the success parameter(s) define the criteria for determining whether or not AI agent 160P performs a task successfully. The success parameter(s) may be included within a configuration of AI agent 160P.

In subprocess 630, disclosed embodiments may be used to test and evaluate the new or modified AI agent 160P. In particular, an end client 302 may provide test inputs to AI agent 160P, such as manual invocations, and the performance of AI agent 160P may be evaluated using monitoring service 116 and monitoring AI agent(s) 160P, as discussed with respect to data flow 300 and processes 400 and 500. As discussed elsewhere, the evaluation may comprise computing one or more performance metrics of AI agent 160P and evaluating the adherence of AI agent 160P to the behavior represented by one or more success parameters.

In subprocess 640, it is determined whether or not the new or modified AI agent 160P has proven successful during the testing, based on the evaluations. For instance, a user may review the performance data (e.g., using analytics service 118), stored for AI agent 160P in subprocess 630, and determine whether or not the performance data indicate that AI agent 160P is able to reliably perform its assigned task (e.g., based on an effectiveness score, trust score, etc.). When determining that AI agent 160P is able to reliably perform the task (i.e., “Yes” in subprocess 640), flow 600 may proceed to subprocess 650. Otherwise, when determining that AI agent 160P is not able to reliably perform the task (i.e., “No” in subprocess 640), flow 600 may return to subprocess 610, so that AI agent 160P can be modified (e.g., according to optimization suggestions provided in the performance data stored for AI agent 160P).

In subprocess 650, performing AI agent 160P may be deployed to the production environment. In particular, AI agent 160P may be moved from the development environment to the production environment. In the production environment, AI agent 160P may interact with other software entities within the production environment and act on production data.

In subprocess 660, disclosed embodiments may once again be used to test and evaluate the newly deployed performing AI agent 160P. In particular, in the production environment, additional testing may be performed by inputting random samples into AI agent 160P, with the sampling frequency determined by the runtime configuration of AI agent 160P. It should be understood that subprocess 660 may be similar or identical to subprocess 630, except that AI agent 160P is now executing within the production environment. Results of the evaluation may be persisted in database 114 for consumption by analytics service 118 and/or humans.

In subprocess 670, it is determined whether or not the newly deployed AI agent 160P has proven successful during the testing, based on the evaluations, within the production environment. It should be understood that subprocess 670 may be similar or identical to subprocess 640, except that AI agent 160P is now within the production environment. When determining that AI agent 160P is able to reliably perform the task (i.e., “Yes” in subprocess 670), flow 600 may end. Otherwise, when determining that AI agent 160P is not able to reliably perform the task (i.e., “No” in subprocess 670), flow 600 may return to subprocess 610, so that AI agent 160P can be modified (e.g., according to optimization suggestions provided in the performance data stored for AI agent 160P). In this manner, AI agent 160P may go through a plurality of tuning iterations, comprising, testing, evaluation, and optimization, to achieve a desired effectiveness and/or trust score (e.g., greater than or equal to a threshold value), before being persisted within the production environment.

Notably, disclosed embodiments treat an AI agent 160P more like a human when measuring performance metrics that measure effectiveness, including behavioral metrics, while providing more control and visibility. For instance, the utilization of success parameter(s) enables automated control of the measure of success, which may be dynamically varied based on the complexity of the task being performed. In addition, unlike state-of-the-art evaluation techniques, which evaluate model performance offline, disclosed embodiments may evaluate the effectiveness of AI agents 160P, and provide visualization of evaluations, in real time. These real-time evaluations can be fed into a feedback loop for dynamic optimization of AI agent 160P.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A. B. and/or C. For example, a combination of A and B may comprise one A and multiple B's, multiple A's and one B, or multiple A's and multiple B's.

What is claimed is:

1. A method comprising using at least one hardware processor to:
by a monitoring service,
receive session data for a session between an end client and a performing artificial intelligence (AI) agent from a model gateway and a tool gateway, wherein the model gateway is a gateway between the performing AI agent and at least one AI model, and wherein the tool gateway is a gateway between the performing AI agent and at least one tool,
invoke one or more monitoring AI agents to evaluate a performance of the performing AI agent based on the session data;
by the each of the one or more monitoring AI agents,
derive one or more performance metrics based on the session data, evaluate the performance of the performing AI agent based on the one or more performance metrics, and
return a result of the evaluation to the monitoring service; and by the monitoring service,
receive the result of the evaluation from each of the one or more monitoring AI agents,
derive performance data based on the received result of the evaluation from each of the one or more monitoring AI agents, and
store the performance data.

2. The method of claim 1, further comprising using the at least one hardware processor to, by the monitoring service:
determine a task complexity score for a task being performed by the performing AI agent;
determine one or more success parameters based on the task complexity score; and
provide the one or more success parameters to the one or more monitoring AI agents,
wherein the evaluation by each of the one or more monitoring AI agents is based on the one or more performance metrics and the one or more success parameters.

3. The method of claim 1, further comprising using the at least one hardware processor to, by the monitoring service:
determine whether or not the performing AI agent is likely to successfully complete a task being performed by the performing AI agent; and
when determining that the performing AI agent is not likely to successfully complete the task, initiate at least one remedial action.

4. The method of claim 3, wherein the remedial action comprises terminating the task being performed by the performing AI agent.

5. The method of claim 3, wherein the remedial action comprises terminating execution of the performing AI agent.

6. The method of claim 3, wherein the remedial action comprises modifying a configuration of the performing AI agent.

7. The method of claim 1, further comprising using the at least one hardware processor to, by an agent framework service, create the session by:
generating a session identifier for the session; and
instantiating the performing AI agent.

8. The method of claim 7, further comprising using the at least one hardware processor to, by the agent framework service, call the monitoring service to evaluate the performance of the performing AI agent.

9. The method of claim 1, further comprising, by the monitoring service, computing one or more raw metrics based on the session data, wherein the one or more performance metrics are derived further based on the one or more raw metrics.

10. The method of claim 1, wherein deriving the one or more performance metrics comprises applying an AI model to the session data.

11. The method of claim 10, wherein the AI model is a large language model.

12. The method of claim 1, wherein the result of the evaluation comprises at least one of the one or more performance metrics.

13. The method of claim 1, wherein the result of the evaluation comprises an effectiveness score, wherein the effectiveness score comprises a numerical value representing how effective the performing AI agent was at an instructed task.

14. The method of claim 1, wherein the result of the evaluation comprises a trust score, wherein the trust score comprises a numerical value representing how reliably the performing AI agent followed expected behavior.

15. The method of claim 1, further comprising using the at least one hardware processor to, by an analytics service:
retrieve the stored performance data; and
generate an interactive graphical user interface based on the retrieved performance data.

16. The method of claim 1, wherein the one or more monitoring AI agents are a plurality of monitoring AI agents, and wherein each of the plurality of monitoring AI agents evaluates the performance of the performing AI agent in parallel with at least one other one of the plurality of monitoring AI agents.

17. The method of claim 16, wherein the evaluation performed by each of the plurality of monitoring AI agents differs from the evaluation performed by the at least one other one of the plurality of monitoring AI agents.

18. The method of claim 1, wherein the one or more performance metrics comprise one or more of work completion rate, instruction adherence, tool usage efficiency, latency, or task complexity score.

19. A system comprising:
at least one hardware processor; and
software that is configured to, when executed by the at least one hardware processor, perform the method of claim 1.

20. A non-transitory computer-readable medium having instructions stored therein, wherein the instructions, when executed by a processor, cause the processor to perform the method of claim 1.
